(19) United States
(12) Patent Application Publication
(10) Pub. No.: US 2024/0054187 A1
(43) Pub. Date: Feb. 15, 2024

(54) INFORMATION PROCESSING APPARATUS, ANALYSIS METHOD, AND STORAGE MEDIUM

(71) Applicant: NEC Corporation, Minato-ku, Tokyo (JP)

(72) Inventors: Takuma Nozawa, Tokyo (JP); Masafumi Oyamada, Tokyo (JP); Yuyang Dong, Tokyo (JP); Genki Kusano, Tokyo (JP)

(73) Assignee: NEC Corporation, Minato-ku, Tokyo (JP)

(21) Appl. No.: 18/266,745

(22) PCT Filed: Oct. 25, 2021
(86) PCT No.: PCT/JP2021/039367

§ 371 Date: Jun. 12, 2023

(30) Foreign Application Priority Data
Dec. 22, 2020 (JP) 2020-212788

(51) Int. Cl. G06F 18/241

(52) U.S. Cl. CPC G06F 18/241

(57) ABSTRACT

It is possible to detect an insight between a plurality of data sets. An information processing apparatus (1) includes: a classification unit (11) that groups, by insight to be detected, a plurality of insight subjects each being data generated from each of a plurality of data sets by associating a plurality of data items contained in each of the plurality of data sets with each other; and an evaluation unit (12) that calculates, for a combination of the plurality of insight subjects which have been grouped, an evaluation value for determining the presence or absence of an insight.

### TECHNICAL FIELD

The present invention relates to an information processing apparatus and the like that carry out analysis of data sets.

### BACKGROUND ART

In recent years, in various fields, meaningful findings for humans have been discovered by collecting data and analyzing the data. Such findings are called insights. In a general data analysis work, an analyst discovers an insight by repeating the cycle of setting a hypothesis, analyzing and visualizing data on the basis of the set hypothesis, and verifying the hypothesis.

Since the data analysis work as described above for discovering an insight is very time-consuming and labor-intensive, the development of a technique for automating the data analysis work has been pursued. For example, Patent Literature 1 below discloses a system for providing an insight automatically from a data set. An analyzer need only enter multi-dimensional data to be analyzed into the system described in Patent Literature 1. Thus, an insight is automatically determined by the system, and the determined insight is displayed on the display.

### CITATION LIST

### Patent Literature

### Patent Literature 1

Specification of U.S. Pat. No. 2020/0257682

### SUMMARY OF INVENTION

### Technical Problem

In the technique described in Patent Literature 1, there is room for improvement in that it is not possible to detect an insight between a plurality of data sets. For example, by analyzing both a data set consisting of product sales data for one company and a data set consisting of product sales data for another company, there is the possibility that an insight that cannot be obtained from only one of the data sets may be found.

However, in the technique described in Patent Literature 1, it is not assumed to detect an insight between such a plurality of data sets. Thus, as a matter of course, in the technique described in Patent Literature 1, it is impossible to detect an insight between a plurality of data sets.

An example aspect of the present invention is attained in view of the above problem, and its example object is to provide an information processing apparatus and the like that make it possible to detect an insight between a plurality of data sets.

### Solution to Problem

An information processing apparatus according to an example aspect of the present invention includes: a classification means that groups, by insight to be detected, a plurality of insight subjects each being data generated from each of a plurality of data sets by associating a plurality of data items contained in each of the plurality of data sets with each other; and an evaluation means that calculates, for a combination of the plurality of insight subjects which have been grouped, an evaluation value for determining the presence or absence of an insight.

An analysis method according to an example aspect of the present invention includes: at least one processor grouping, by insight to be detected, a plurality of insight subjects each being data generated from each of a plurality of data sets by associating a plurality of data items contained in each of the plurality of data sets with each other; and the at least one processor calculating, for a combination of the plurality of insight subjects which have been grouped, an evaluation value for determining the presence or absence of an insight.

An analysis program according to an example aspect of the present invention causes a computer to carry out: a process of grouping, by insight to be detected, a plurality of insight subjects each being data generated from each of a plurality of data sets by associating a plurality of data items contained in each of the plurality of data sets with each other; and a process of calculating, for a combination of the plurality of insight subjects which have been grouped, an evaluation value for determining the presence or absence of an insight.

### Advantageous Effects of Invention

An example aspect of the present invention makes it possible to detect an insight between a plurality of data sets.

### BRIEF DESCRIPTION OF DRAWINGS

FIG. 1 is a block diagram illustrating a configuration of an information processing apparatus according to a first example embodiment of the present invention.

FIG. 2 is a flowchart illustrating a flow of an analysis method according to the first example embodiment of the present invention.

FIG. 3 is a view illustrating an overview of a process that is carried out by an information processing apparatus according to a second example embodiment of the present invention.

FIG. 4 is a block diagram illustrating a configuration of the information processing apparatus according to the second example embodiment of the present invention.

FIG. 5 is a flowchart illustrating a flow of an analysis method according to the second example embodiment of the present invention.

FIG. 6 is a diagram illustrating examples of analysis target data and insight subjects generated from the analysis target data.

FIG. 7 is a diagram illustrating examples of evaluation result data and output data.

FIG. 8 is a block diagram illustrating a configuration of an information processing apparatus according to a third example embodiment of the present invention.

FIG. 9 is a flowchart illustrating a flow of an analysis method according to the third example embodiment of the present invention.

FIG. 10 is a view for describing a method of calculating an insight score and a method of detecting an outlier.

FIG. 11 is a view illustrating an example of a computer that executes instructions of a program which is software realizing the functions of the information processing apparatus.

### EXAMPLE EMBODIMENTS

### First Example Embodiment

The following description will discuss a first example embodiment of the present invention in detail with reference to the drawings. The present example embodiment is a basic form of an example embodiment described later.

(Configuration of Information Processing Apparatus 1)

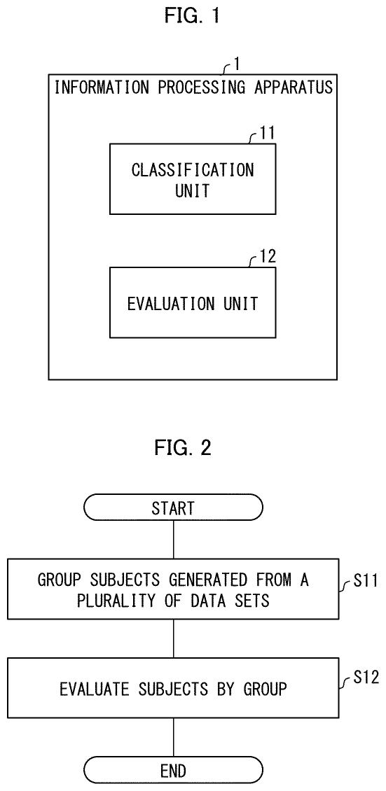

The following description will discuss a configuration of an information processing apparatus 1 according to the present example embodiment with reference to FIG. 1. FIG. 1 is a block diagram illustrating a configuration of the information processing apparatus 1. As illustrated in FIG. 1, the information processing apparatus 1 includes a classification unit 11 and an evaluation unit 12.

The classification unit 11 groups, by insight to be detected, a plurality of insight subjects each being data generated from each of a plurality of data sets by associating a plurality of data items contained in each of the plurality of data sets with each other. In carrying out the grouping, the classification unit 11 groups insight subjects for which an evaluation value can be calculated by the evaluation unit 12. Note that the insight to be detected is hereinafter referred to as insight type. As the insight type, at least one insight type need only be set. Details of the insight type are described in the second example embodiment.

Then, the evaluation unit 12 calculates, for a combination of the plurality of insight subjects which have been grouped, an evaluation value for determining the presence or absence of an insight. This evaluation value is hereinafter referred to as insight score.

For example, in a case where a data set representing monthly sales record of a certain store is a target to be analyzed, data representing total sales by day in that store (data in which data items of dates and total sales are associated with each other) can be regarded as an insight subject. Similarly, data representing sales by day of a certain product in that store (data in which data items of a date and sales of a certain product are associated with each other) can be regarded as an insight subject. Since such insight subjects can be visualized in the form of, for example, a chart or the like, the insight subjects can also be referred to as visualization patterns. It can also be said that the insight subject is one that characterizes each visualization pattern obtained from a data set that is multi-dimensional data. In this case, one visualization pattern is associated per insight subject.

Further, in a case where the insight to be detected, that is, the insight type is, for example, a correlation between insight subjects, the classification unit 11 groups the insight subjects for which an insight score (for example, a correlation coefficient) for determining the presence or absence of a correlation can be calculated. For example, in the above example, the classification unit 11 may group insight subjects that indicate a relationship between a date and sales in each store. This allows the evaluation unit 12 to calculate an insight score for the date and sales in each store. Insight scores are a great help for users to discover an insight even in a case where the insight scores are outputted as they are. The use of insight scores also makes it possible to automatically detect a combination of insight subjects an insight score for which is high, that is, a combination of insight subjects that are highly likely to be an insight.

As described above, the information processing apparatus 1 according to the present example embodiment employs a configuration of including: the classification unit 11 that groups, by insight to be detected, a plurality of insight subjects generated from each of a plurality of data sets; and the evaluation unit 12 that calculates, for a combination of the plurality of insight subjects which have been grouped, an evaluation value for determining the presence or absence of an insight.

Thus, the information processing apparatus 1 according to the present example embodiment produces the effect of making it possible to detect an insight between a plurality of data sets. In other words, the information processing apparatus 1 according to the present example embodiment makes it possible to present, to a user, data that may lead to the discovery of a composite insight obtained by subjecting a plurality of data sets to cross-sectional analysis (hereinafter, referred to as a cross-sectional composite insight).

Note that the above-described functions of the information processing apparatus 1 can also be realized by a program. An analysis program according to the present example embodiment causes a computer to carry out: a process of grouping, by insight to be detected, a plurality of insight subjects generated from each of a plurality of data sets; and a process of calculating, for a combination of the plurality of insight subjects which have been grouped, an evaluation value for determining the presence or absence of an insight. Thus, the analysis program according to the present example embodiment produces the effect of making it possible to detect an insight between a plurality of data sets, that is, a cross-sectional composite insight.

(Flow of Analysis Method)

A flow of an analysis method according to the present example embodiment will be described with reference to FIG. 2. FIG. 2 is a flowchart illustrating a flow of the analysis method according to the present example embodiment.

In S11, at least one processor groups, by insight type, a plurality of insight subjects generated from each of the plurality of data sets. Then, in S12, the at least one processor calculates, for a combination of the plurality of insight subjects which have been grouped in S11, an insight score which is an evaluation value for determining the presence or absence of an insight. This is the end of the analysis method in FIG. 2.

Note that the processes in S11 and S12 may be carried out by one processor. Alternatively, the process in S11 may be carried out by one processor, and the process in S12 may be carried out by another processor. In the latter case, the processors may be processors that are provided in one information processing apparatus or may be processors that are provided in respective different information processing apparatuses. Further, the at least one processor that carries out the processes in S11 and S12 may be a processor(s) that is/are provided in the information processing apparatus 1.

As described above, the analysis method according to the present example embodiment employs a configuration of including: at least one processor grouping, by insight type, a plurality of insight subjects generated from each of a plurality of data sets; and the at least one processor calculating, for a combination of the plurality of insight subjects which have been grouped, an insight score for determining the presence or absence of an insight. Thus, the analysis method according to the present example embodiment produces the effect of making it possible to detect an insight between the plurality of data sets, that is, a cross-sectional composite insight.

### Second Example Embodiment

(Overview)

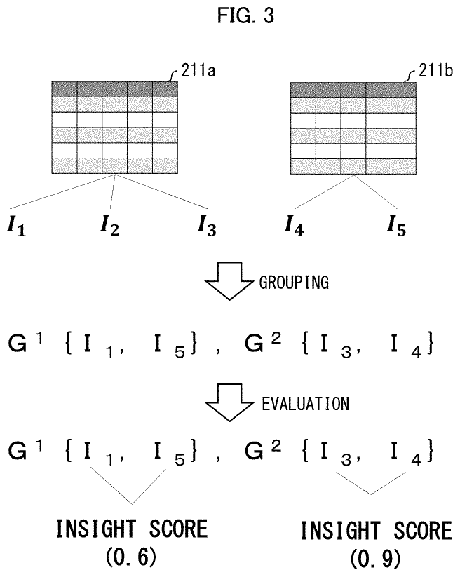

A second example embodiment of the present invention will be described in detail with reference to the drawings. In the present example embodiment, an information processing apparatus 2 that receives input of a plurality of data sets and outputs information on an insight about the data sets will be described. FIG. 3 is a view illustrating an overview of a process that is carried out by the information processing apparatus 2.

First, the information processing apparatus 2 acquires analysis target data 211a and 211b to be analyzed. The analysis target data 211a and 211b are each a data set of multi-dimensional data which includes a plurality of records. Note that, when it is not necessary to distinguish between the analysis target data 211a and 211b, the analysis target data 211a and 211b will be referred to simply as analysis target data 211. The analysis target data 211a and 211b illustrated in FIG. 3 are each data in tabular format.

Next, the information processing apparatus 2 generates insight subjects from each of the acquired analysis target data 211a and 211b. In an example in FIG. 3, three insight subjects I₁ to I₃ are generated from the analysis target data 211a, and two insight subjects 14 and 15 are generated from the analysis target data 211b.

Subsequently, the information processing apparatus 2 groups the generated insight subjects I₁ to I₅. In the example in FIG. 3, the insight subjects I₁ and I₅ are classified into a group G¹, and the insight subjects I₃ and I₄ are classified into a group G². The insight types of the groups G¹ and G² may be the same or different. However, in a case where the insight types of the groups G¹ and G² are the same, mutually different insight subjects are classified into each of the groups.

Then, the information processing apparatus 2 calculates, for a combination of insight subjects included in each group, an insight score which is an evaluation value for determining the presence or absence of an insight. In the example in FIG. 3, the insight score for the insight subjects I₁ and I₅ is calculated to be 0.6, and the insight score for the insight subjects 13 and 14 is calculated to be 0.9. The insight score may be, for example, one that indicates the degree of correlation between insight subjects by a numerical value of 0 to 1 (the greater the numerical value, the higher the degree of correlation). In this case, there is a high correlation between the insight subjects 13 and 14.

Here, the insight subject 13 is generated from the analysis target data 211a. The insight subject 14 is generated from the analysis target data 211b. In addition, the finding that there is a high correlation between the insight subjects I₃ and I₄ is useful for humans. That is, according to the information processing apparatus 2, it is possible to detect an insight between a plurality of data sets, that is, a cross-sectional composite insight. Note that, although the details will be described below, the information processing apparatus 2 makes it possible to detect various insights, in addition to a correlation.

(Configuration of Information Processing Apparatus 2)

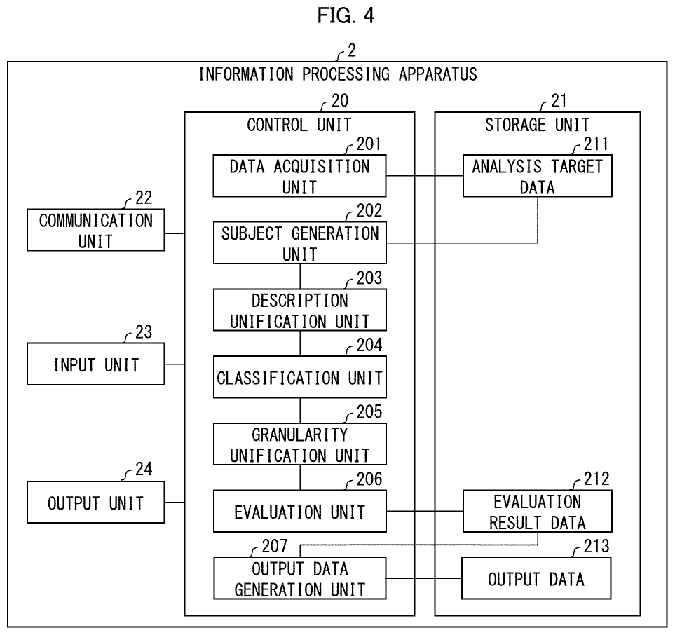

FIG. 4 is a block diagram illustrating a configuration of the information processing apparatus 2. The information processing apparatus 2 includes a control unit 20 that centrally controls each unit of the information processing apparatus 2 and a storage unit 21 that stores various data used by the information processing apparatus 2. The information processing apparatus 2 further includes a communication unit 22 for allowing the information processing apparatus 2 to communicate with another apparatus, an input unit 23 that receives an input to the information processing apparatus 2, and an output unit 24 for allowing the information processing apparatus 2 to output data. The following will describe an example in which the output unit 24 is a display apparatus that displays and outputs data. However, a form of an output produced by the output unit 24 can be any form. For example, the output unit 24 may produce an output of data in the form of, for example, printed output and/or voice output. The input unit 23 and the output unit 24 may be apparatuses that are external to the information processing apparatus 2 and that are externally mounted to the information processing apparatus 2.

The control unit 20 includes a data acquisition unit 201, a subject generation unit 202, a description unification unit 203, a classification unit 204, a granularity unification unit 205, an evaluation unit 206, and an output data generation unit 207. Further, the storage unit 21 stores the analysis target data 211, evaluation result data 212, and output data 213.

The analysis target data 211 is data to be analyzed by the information processing apparatus 2. The analysis target data 211 includes a plurality of data sets. Each of the data sets is multi-dimensional data including a plurality of records. The evaluation result data 212 is data showing the result of evaluation performed on the analysis target data 211 by the evaluation unit 206. The output data 213 is data for presenting, to the user, the result of analysis performed on the analysis target data 211 by the information processing apparatus 2, that is, data related to an insight of the analysis target data 211.

The data acquisition unit 201 acquires a plurality of data sets to be analyzed by the information processing apparatus 2 and causes the data sets to be stored as the analysis target data 211 in the storage unit 21. The data acquisition unit 201 need only acquire the analysis target data 211 and store the analysis target data 211 in the storage unit 21 by the time analysis starts. A method for acquiring the analysis target data 211 is not particularly limited. As an example, the data acquisition unit 201 may acquire the data sets inputted by the user of the information processing apparatus 2 via the input unit 23. As another example, the data acquisition unit 201 may acquire the analysis target data 211 from an external apparatus through communications via the communication unit 22.

The subject generation unit 202 generates insight subjects from each of a plurality of data sets included in the analysis target data 211. More particularly, the subject generation unit 202 generates insight subjects from each of a plurality of data sets by associating a plurality of data items contained in the plurality of data sets with each other. For example, in a case where a certain data set is multi-dimensional data including data items which are dates, sales, and locations, the subject generation unit 202 generates an insight subject in which the dates and the sales are associated with each other and an insight subject in which the locations and the sales are associated with each other.

The description unification unit 203 unifies the descriptions in data in each insight subject. More particularly, the description unification unit 203 unifies the descriptions in the insight subjects by extracting similar words from among words contained in the insight subjects and then replacing those similar words with one word. Note that the above-described “similar” includes not only similarity in character strings of words and similarity in meaning.

For example, the words “Tokyo Prefecture” which represent a place of sale of a product in one data set are words that have similarities in meaning and in character strings to the word “Tokyo” which represents a place of sale of a product in another data set. These words can be called nonuniform descriptions. Further, for example, the word “Prefectures” which represents a place of sale of a product in one data set is a word that has similarity in meaning to the word “Location” which represents a place of sale of a product in another data set.

Any method for extracting such similar words can be employed. The description unification unit 203 may extract words which are nonuniform descriptions, like “Tokyo” and “Tokyo Prefecture”. In this case, the description unification unit 203 may extract, for example, words that are close in edit distance between the words. The edit distance, also called Levenshtein distance, is a distance that indicates how different two character strings are. In determining the edit distance, the description unification unit 203 determines the number of times a character string which constitutes one of the words to be compared needs to be changed (deleted, inserted, or substituted) so as to be converted into a character string which constitutes the other of the words to be compared. In addition, the analysis target data 211 may be subjected to extraction of similar words on the basis of, for example, the Jaro-Winkler distance which is a distance for measuring the lengths of two character strings and the necessity or nonnecessity of substitution (partial matching).

Further, in a case where words with similarity in meaning are to be extracted, for example, words contained in the data sets of the analysis target data 211 may be represented in distributed representations so that words with a high degree of similarity in the distributed representations are extracted. For derivation of the distributed representations, for example, a program such as word2vec can be used.

After having extracted similar words, the description unification unit 203 unifies the descriptions of those words. For example, the description unification unit 203 may unify the descriptions of two similar words by replacing one of the two similar words with the other of the two similar words. Alternatively, the description unification unit 203 may unify the descriptions of two similar words by replacing the two similar words with a broader concept word that encompasses those words.

The classification unit 204 groups insight subjects generated by the subject generation unit 202. More specifically, the classification unit 204 groups insight subjects for which an insight score that is an evaluation value for determining the presence or absence of an insight can be calculated. This makes it possible to detect an insight on the basis of the insight score. Note that one group can contain any number of insight subjects. In addition, one group can contain insight subjects obtained from different data sets. One group preferably contains at least one insight subject.

Note that, in a case where the description unification unit 203 has unified the descriptions of a plurality of insight subjects, the evaluation unit 206 groups the insight subjects in which descriptions have been unified into a single description. In many cases, descriptions are nonuniform between different data sets. In general, nonuniform descriptions often hinder evaluations. However, the information processing apparatus 2 makes it possible to carry out evaluations even in such cases. That is, the information processing apparatus 2 produces, in addition to the effect brought about by the information processing apparatus 1 according to the first example embodiment, the effect of making it possible to detect a cross-sectional composite insight even for data sets with nonuniform descriptions.

For example, in a case where there are a plurality of insight subjects that indicate sales by year, series names of these insight subjects are both “year” and “sales”. Thus, the classification unit 204 classifies those insight subjects into one group. In addition, even in a case where some of these insight subjects have series names with other description such as “sales”, the description unification unit 203 unifies the descriptions, so that the classification unit 204 classifies those descriptions into one group.

Here, as described above, grouping is carried out by insight type. Thus, a grouping criterion is determined in advance for each insight type. The insight type is, for example, a correlation. In a case where insight subjects whose insight type is a correlation are grouped, the classification unit 204 need only group insight subjects from which the strength of a correlative relationship can be evaluated, in other words, insight subjects from which a correlation coefficient can be calculated. In addition, in a case where insight subjects whose insight type is an outlier are grouped, the classification unit 204 need only group insight subjects from which an outlier can be detected, that is, insight subjects from which a distance between corresponding pieces of data can be calculated. Specifically, for example, the classification unit 204 may classify, into one group, insight subjects that have the same word indicative of each series name.

As the insight type, any insight type other than the correlation can be employed. In a case where a cross-sectional composite insight is detected, an insight type such as, for example, cross-measure correlation, two-dimensional clustering, and attribution may be set.

Further, for example, the classification unit 204 may group single point insights, that is, insight subjects with non-ordinal dimension on the horizontal axis with one insight subject as an input. Such grouping makes it possible to detect, for example, an insight such as Outstanding No. 1, Outstanding No. Last, Outstanding Top 2, and Evenness. Further, the classification unit 204 may group single shape insights, that is, insight subjects with an ordinal dimension on the horizontal axis with one insight subject as an input. Note that data having an ordinal dimension on the horizontal axis is, for example, time-series data. Such grouping makes it possible to detect an insight such as a change point, a trend, seasonality, and an outlier. The set insight type need only include at least one insight type from which a cross-sectional composite insight can be detected (for example, a correlation and the like), and may include an insight type from which a non-cross-sectional composite insight is detected (for example, a change point and the like).

The granularity unification unit 205 unifies the granularities of data in insight subjects. This process is a process for enabling the evaluation unit 206 to evaluate the relevance between insight subjects, and is thus performed on data with uneven granularity. The granularity unification may be carried out on an insight subject generated from a data set or may be performed in advance on a plurality of data sets to be analyzed. Note that the granularity of data indicates the degree of fineness (unit) a series of data have.

For example, in a case where one insight subject and another insight subject each indicate sales by month, the former indicating monthly sales, the latter indicating sales by alternate month (odd month), the granularities of these pieces of data are not uniform. In this case, it may not be possible to evaluate the distance or similarity between the two pieces of data.

The granularity unification unit 205 carries out a process of making the granularities of such data uniform. For example, the granularity unification unit 205 may impute data by missing value imputation to make the granularity uniform, or may make the granularity uniform by downsampling. Missing value imputation is a process of predicting a missing part from other data and performing imputation, and specific examples of the missing value imputation include interpolation. Downsampling is a process of adjusting the sampling granularity to a coarser one.

In a case where missing value imputation is carried out in the above-described example, the granularity unification unit 205 imputes sales in even months in other insight subjects. In addition, in a case where downsampling is carried out in the above-described example, the granularity unification unit 205 allows only odd-month sales in an insight subject to be used for evaluation made by the evaluation unit 206.

The evaluation unit 206 calculates an insight score for a combination of a plurality of insight subjects classified into the same group by the classification unit 204, generates evaluation result data 212 indicating the calculation result, and stores the evaluation result data 212 in the storage unit 21. For example, the evaluation unit 206 may carry out the above evaluation using a function f_{T} that receives, as an input, a combination of insight subjects classified into the same group and returns an insight score.

The function f_{T} is a function predefined for each insight type T and is designed to be a large value when an insight subject giving the insight to be detected is input. Assuming that the insight group corresponding to the insight type T is GT, the insight score is expressed by the following equation:

(Insight score)=f_{T}(I₁,I₂, . . . ,Iₙ|Iᵢ∈G_{T})

The evaluation unit 206 may calculate the insight score of each set by taking a plurality of insight subjects classified into the same group as a set. In this case, it is only necessary to use f_{T} which receives input of two insight subjects. For example, in a case where three insight subjects of I₁ to I₃ are grouped, the evaluation unit 206 calculates the respective insight scores of sets I₁ and I₂, I₁ and I₃, and I₂ and I₃ by inputting each of the sets into f_{T}.

A method of calculating the insight score need only be determined according to the insight type. For example, in a case where the degree of linear correlation between the insight subjects that are a set is evaluated, the evaluation unit 206 may calculate the insight score using f_{T} that calculates the Pearson correlation coefficient. In addition, for example, the evaluation unit 206 may calculate, as the insight score, Spearman rank correlation coefficient, cosine similarity, Euclidean distance and Earth Mover's distance (EMD) between the corresponding pieces of data, and the like.

Note that, in a case where the granularity unification unit 205 has unified granularities of data of the insight subjects, the evaluation unit 206 calculates an insight score for a combination of a plurality of insight subjects in which the granularities have been unified. In many cases, data granularities are nonuniform between different data sets. In general, nonuniform granularities often hinder evaluations. However, the information processing apparatus 2 makes it possible to carry out evaluations even in such cases. That is, the information processing apparatus 2 produces, in addition to the effect brought about by the information processing apparatus 1 according to the first example embodiment, the effect of making it possible to detect a cross-sectional composite insight even for data sets including data in which granularities are non-uniform.

The output data generation unit 207 generates the output data 213 using the evaluation result data 212. Although the output data generation unit 207 is not an essential constituent component of the information processing apparatus 2, provision of the output data generation unit 207 allows the result of analysis by the information processing apparatus 2 to be presented to the user in an easier-to-recognize manner.

(Flow of Analysis Method)

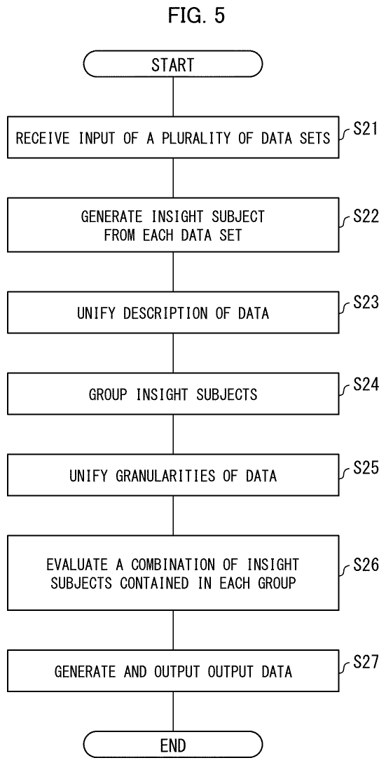

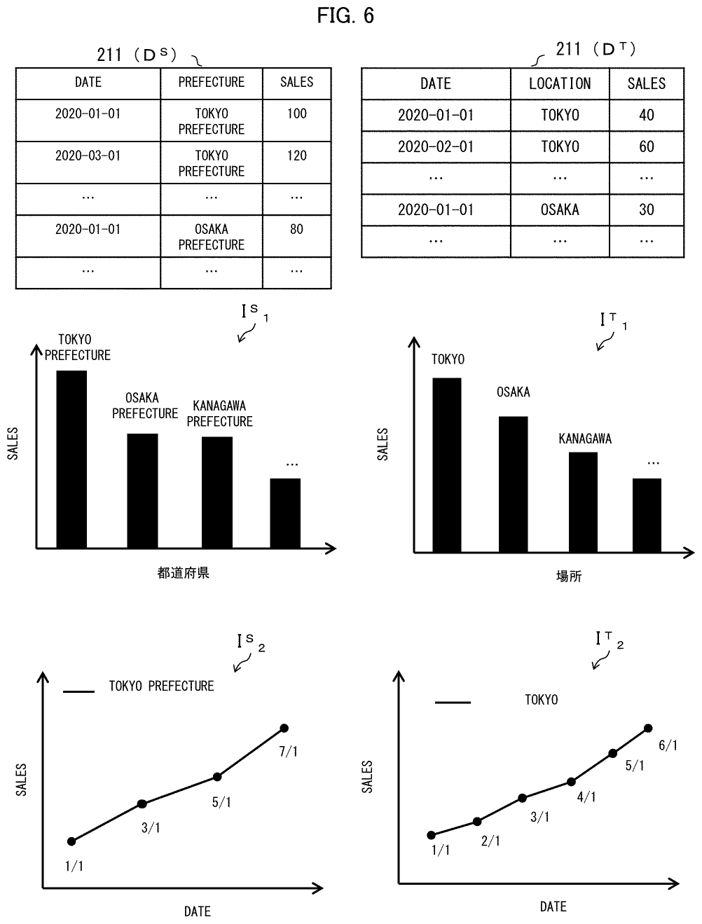

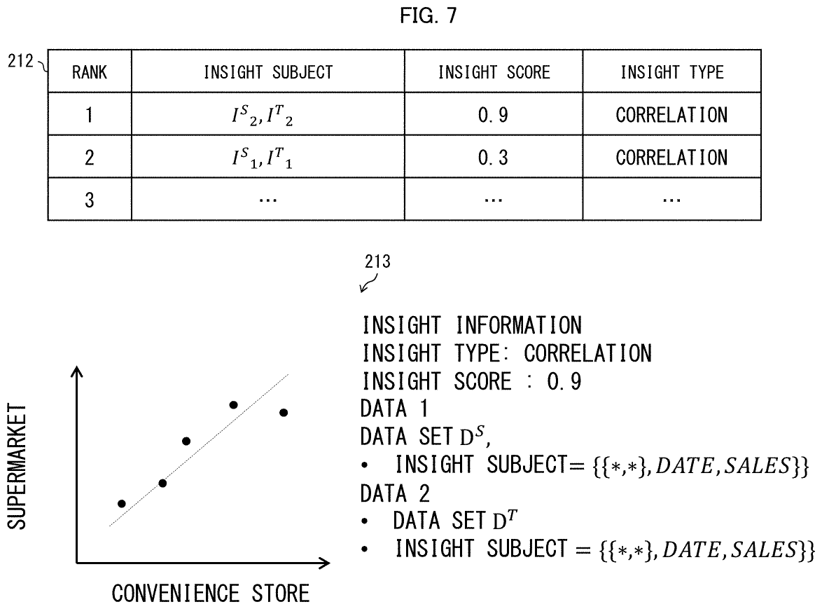

A flow of an analysis method according to the present example embodiment will be described with reference to FIGS. to 7. FIG. 5 is a flowchart illustrating a flow of an analysis method. FIG. 6 is a diagram illustrating examples of the analysis target data 211 and insight subjects generated from the analysis target data 211. Then, FIG. 7 is a diagram illustrating examples of the evaluation result data 212 and the output data 213.

In S21, the data acquisition unit 201 receives input of a plurality of data sets, and stores the plurality of data sets as the analysis target data 211 in the storage unit 21. For example, the data acquisition unit 201 receives, via the input unit 23, the input of the analysis target data 211 illustrated in FIG. 6. The analysis target data 211 includes: a data set (Ds) indicating sales of each month by prefecture in convenience stores; and a data set (DT) indicating sales of each month by prefecture in supermarkets.

In S22, the subject generation unit 202 generates an insight subject from each data set included in the analysis target data 211. For example, in a case where the data sets Ds and DT illustrated in FIG. 6 are used, the subject generation unit 202 can generate insight subjects I^{S}₁ and I^{S}₂ from the data set Ds and generate insight subjects I^{T}₁ and I^{T}₂ from the data set DT.

The insight subject I^{S}₁ indicates sales by prefecture in convenience stores. In FIG. 6, I^{S}₁ is shown as a bar graph of sales (where the horizontal axis represents prefecture, and the vertical axis represents sales). In addition, the insight subject I^{S}₂ indicates monthly sales in convenience stores, and in FIG. 6, I^{S}₂ is shown as a line graph of sales (where the horizontal axis represents date, and the vertical axis represents sales).

Similarly, the insight subject I^{T}₁ indicates sales by prefecture in the supermarkets, and in FIG. 6, I^{T}₁ is shown as a bar graph of sales (where the horizontal axis represents prefecture, and the vertical axis represents sales). In addition, the insight subject I^{T}₂ indicates monthly sales in the supermarkets, and in FIG. 6, I^{T}₂ is shown as a line graph of sales (where the horizontal axis represents date, and the vertical axis represents sales).

For example, the insight subject I can also be in a data format as follows:

I={subspace,breakdown,measure,aggregation}

The “subspace” above indicates how records contained in a data set which is multi-dimensional data have been filtered. The “subspace” corresponds to a legend of each chart. For example, “subspace” in the line graph of I^{S}₂ in FIG. 6 is “TOKYO PREFECTURE”. No filtering may be indicated by a symbol such as “*”.

The “breakdown” indicates a column that is used as a key to aggregate a data set which is multi-dimensional data. The “breakdown” corresponds to the horizontal axis of each chart. For example, “breakdown” in the line graph of I^{S}₂ in FIG. 6 is “DATE”.

The “measure” indicates a column that is used as numerical data in a data set which is multi-dimensional data. The “measure” corresponds to the vertical axis of each chart. For example, “measure” in the line graph of I^{S}₂ in FIG. 6 is numerical data of “SALES”.

The “aggregation” indicates a method (e.g., a function) of aggregating data for each “breakdown”. Examples of the “aggregation” include a sum, an average, a maximum value, a minimum value, and the like. In a case where the function used for aggregation is “sum”, “aggregation” may be omitted.

For example, I^{S}₂ illustrated in FIG. 6 can be expressed as I^{S}₂={{*, Tokyo prefecture}, date, sales}. In S22, the subject generation unit 202 may generate an insight subject in such a data format from each data set included in the analysis target data 211.

In S23, the description unification unit 203 unifies the description of data in each insight subject generated in S22. For example, in I^{S}₁, I^{S}₂, I^{T}₁, and I^{T}₂ illustrated in FIG. 6, the meanings of the label “PREFECTURE” on the horizontal axis in I^{S}₁ and the label “LOCATION” on the horizontal axis in I^{T}₁ are similar. Further, series names “TOKYO PREFECTURE”, “OSAKA PREFECTURE”, and “KANAGAWA PREFECTURE” of I^{S}₁ are similar in meaning and description respectively to series names “TOKYO”, “OSAKA”, and “KANAGAWA” of I^{T}₁. The description unification unit 203 extracts such words and unifies their descriptions. For example, the description unification unit 203 may replace the label on the horizontal axis in I^{S}₁ with “LOCATION” and replace the series names “TOKYO PREFECTURE”, “OSAKA PREFECTURE”, and “KANAGAWA PREFECTURE” with “TOKYO”, “OSAKA”, and “KANAGAWA”, respectively.

In S24, the classification unit 204 groups the insight subjects that have been generated in S22 and that have been subjected to description unification in S23. For example, assume that, among I^{S}₁, I^{S}₂, I^{T}₁, and I^{T}₂ illustrated in FIG. 6, insight subjects which are identical to each other in label on the vertical axis and in label on the horizontal axis are grouped. In this case, the classification unit 204 groups I^{S}₁ and I^{T}₁ in which the labels on the vertical axis are “SALES” and the labels on the horizontal axis are “LOCATION”. Such grouping has become possible since “PREFECTURE” in I^{S}₁ has been replaced with “LOCATION” by the description unification unit 203. In addition, the classification unit 204 groups I^{S}₂ and I^{T}₂ in which the labels on the vertical axis are “SALES” and the labels on the horizontal axis are “DATE”.

Assuming that a group containing I^{S}₁ and I^{T}₁ is G¹, a group containing I^{S}₂ and I^{T}₂ is G², the results of grouping are expressed as follows:

I^{S}₁,I^{T}₁∈G¹

I^{S}₂,I^{T}₂∈G²

In S25, the granularity unification unit 205 unifies the granularities of data contained in the insight subjects that have been grouped in S24. For example, the “DATE” of I^{S}₂ illustrated in FIG. 6 is 1st in odd months, whereas the “DATE” of I^{T}₂ is 1st of every month. The granularity unification unit 205 extracts pieces of data having such a difference in granularity and carries out a process of making the granularities of those pieces of data uniform. For example, the granularity unification unit 205 may make the granularity of the “DATE” data uniform by extracting (i.e., downsampling) data in odd months from the “DATE” data in I^{T}₂. Alternatively, the granularity unification unit 205 may make the granularities of the “DATE” data uniform by imputing missing values for the data in even months in I^{S}₂. Note that the missing value imputation is also effective in a case where there is a deviation in the sampling date of data. For example, in a case where the granularity unification unit 205 makes the granularities of data on 1st of every month and data on 15th of every month, the granularity unification unit 205 may generate data on 1st of every month by imputing missing values for data on 15th of every month.

In S26, the evaluation unit 206 evaluates a combination of insight subjects which have been grouped in S24 and in which the granularities of the data have been unified in S25, and stores the evaluation result as the evaluation result data 212 in the storage unit 21. More specifically, the evaluation unit 206 carries out, for each group, a process of pairing insight subjects included in the same group into a set and calculating an insight score for the set.

For example, the evaluation unit 206 may calculate the insight score by using a score function represented by the expression f_{T} (Iᵢ, Iⱼ), that is, a function that receives input of two insight subjects to be evaluated and outputs the insight score. In a case where this score function is used, the insight score of group G¹ is expressed as f_{T} (I^{S}₁, I^{T}₁), and the insight score of group G² is expressed as f_{T} (I^{S}₂, I^{T}₂).

The evaluation unit 206 may generate, for example, evaluation result data 212 as illustrated in FIG. 7 by listing the evaluation results as described above. The evaluation result data 212 illustrated in FIG. 7 is data in a table format that indicates a combination of insight subjects and an insight score calculated for the combination. Further, the evaluation result data 212 illustrated in FIG. 7 also shows “RANK”, which indicates the rank of insight scores, and “INSIGHT TYPE”. In this manner, the evaluation unit 206 may generate the evaluation result data 212 including, in addition to the combination of insight subjects and the insight score calculated for the combination, various types of information related to evaluation.

In S27, the output data generation unit 207 generates the output data 213 using the evaluation result data 212 generated in S26, and outputs the output data 213 to the output unit 24. For example, in a case where the evaluation result data 212 illustrated in FIG. 7 is used, the output data generation unit 207 generates output data 213 indicating a combination of insight subjects having the highest insight score (rank), and outputs the output data 213 to the output unit 24. This is the end of the process in FIG. 5.

The output data 213 may be visualized insight that allows a user to easily recognize the insight. A visualization method need only be determined in accordance with the insight type. For example, in a case where the insight type is “CORRELATION”, the output data generation unit 207 may generate, as the output data 213, a chart (for example, a two-dimensional scatter diagram) suitable for representing the correlative relationship as information about the insight.

The lower side in FIG. 7 shows an example of information about an insight for a combinations of insight subjects having the highest insight score (i.e., the rank is 1), among the combinations of insight subjects shown in the evaluation result data 212. Specifically, the information about the insight illustrated in FIG. 7 includes a scatter diagram showing a correlation between the sales in the supermarkets and the sales in the convenience stores, and insight information indicative of details of the insight. The insight information indicates, in addition to insight types and insight scores, details of insight subjects and the data sets from which the insight subjects originate. Outputting such information to the output unit 24 allows the user of the information processing apparatus 2 to easily recognize an insight such that there is a strong correlation between the transition of the sales in the supermarket and the transition of the sales in the convenience store.

As a matter of course, the information generated by the output data generation unit 207 need only be information such that the insight can be recognized by the user, and is not limited to the example in FIG. 7. For example, the output data generation unit 207 may generate a chart of each insight subject for the combination of insight subjects having the highest insight score, and the chart may be used as the output data 213.

Note that it is not necessary to generate new output data 213 when the analysis result is presented to the user. For example, the evaluation unit 206 may present the analysis result to the user by outputting whole or part of the evaluation result data 212 illustrated in FIG. 7 to the output unit 24. Further, the evaluation unit 206 may output the insight subjects which are ranked 1 or data constituting the insight subjects for which the insight score is equal to or more than a predetermined threshold value. Thus, a manner in which the analysis result is outputted can be any manner and is not limited to the example as illustrated in FIG. 7. In addition, a method of visualizing the analysis result may be selected by the user. In this case, the output data generation unit 207 visualizes the analysis result by the method selected by the user.

Thus, the information processing apparatus 2 can output a chart, data, and the like that may lead to the discovery of an insight as the results of analysis of the plurality of data sets. This eliminates the need to manually compare charts. In addition, even in a case where the user considers an insight eventually, it is possible to easily narrow down data sets that are likely to be useful for analysis. Thus, it is possible to greatly reduce the time required for analysis and visualization.

Further, by using the information processing apparatus 2, there is no room for the occurrence of blurring of the determination criteria when the user carries out entire analysis. Furthermore, it is possible to reduce, for example, the risk of missing or the like that occurs in a case where the user carries out the analysis. In addition, in a case where a large-scale data set is to be analyzed, it is difficult for the user to discover a composite insight. In contrast, the information processing apparatus 2 makes it easy to discover a composite insight (including a cross-sectional composite insight).

Note that, in the flowchart in FIG. 5, the process in S23 need only be carried out before the process in S24, and may be carried out, for example, between S21 and S22. Further, the process in S25 need only be carried out before the process in S26, and may be carried out, for example, between S21 and S22.

(Variations of Handling of Differences in Granularity)

The evaluation unit 206 may evaluate the insight subject by an evaluation method that enables calculation of the insight score even for a combination of a plurality of insight subjects in which granularities of data are different. This produces, in addition to the effect brought about by the information processing apparatus 1 according to the first example embodiment, the effect of making it possible to detect a cross-sectional composite insight even for data sets including data in which the granularities are non-uniform. Further, in this case, the effect of making it possible to omit the granularity unification unit 205 is also produced.

For example, in a case where data on the horizontal axis in insight subjects has an ordinal dimension, the evaluation unit 206 may calculate an insight score by dynamic time warping (DTW) or by functional data analysis. Examples of the data having an ordinal dimension include time series data and the like. In DTW, the shortest path from the edge (1,1) to the edge (n,n) of the cost matrix W, where the distances between the elements of s=(s₁, . . . , sₙ) and t=(t₁, . . . , tₘ) are calculated on a round-robin basis, is obtained by dynamic programming. According to DTW, a distance and similarity between pieces of data with different sample sizes can be calculated, and such distance and similarity can be used for calculation of an insight score. In addition, in a case where function data analysis is used, the evaluation unit 206 can derive a continuous function representing records of each insight subject and calculate the distance and similarity between insight subjects through the function, so that the distance and similarity can be used for calculation of an insight score.

### Third Example Embodiment

A third example embodiment of the present invention will be described in detail with reference to the drawings. In the above-described example embodiments, when insight subjects are grouped, three or more insight subjects may be classified into one group. In such a case, the above-described score function f_{T} (Iᵢ, Iⱼ) cannot evaluate three or more insight subjects together. Further, Patent Literature 1 neither describes nor suggests a method of evaluating three or more insight subjects together.

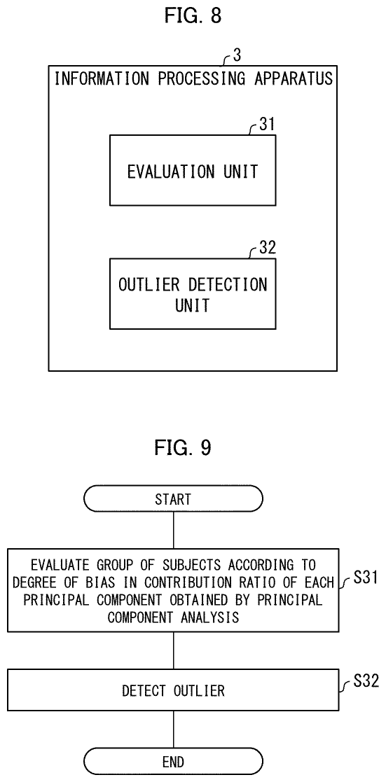

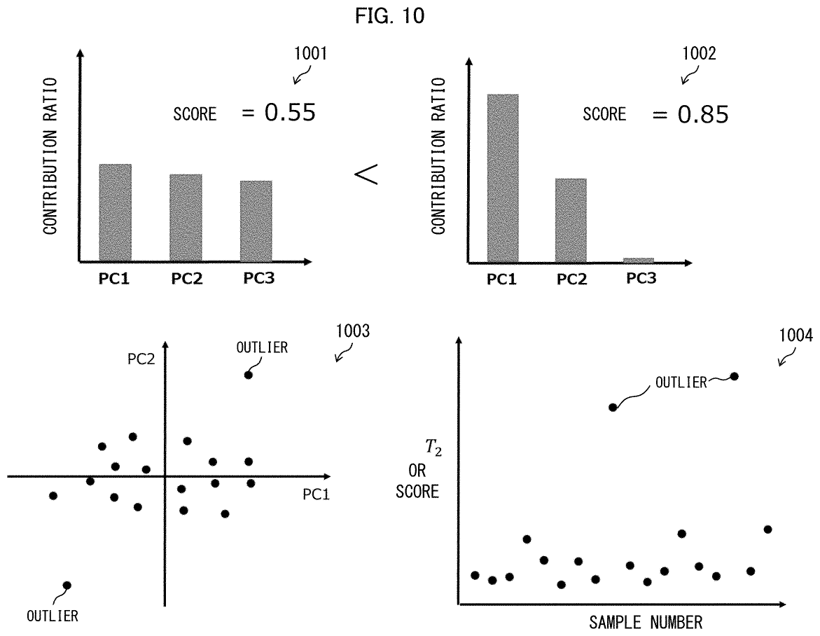

In the present example embodiment, an evaluation method capable of evaluating three or more insight subjects together will be described with reference to FIGS. 8 to 10. FIG. 8 is a block diagram illustrating a configuration of an information processing apparatus 3 according to the present example embodiment. FIG. 9 is a flowchart illustrating a flow of an analysis method according to the present example embodiment. FIG. 10 is a view for describing a method of calculating an insight score and a method of detecting an outlier.

(Configuration of Information Processing Apparatus 3)

As illustrated in FIG. 8, the information processing apparatus 3 includes an evaluation unit 31 and an outlier detection unit 32. Note that, in a case where it is not necessary to detect an outlier, the outlier detection unit 32 may be omitted. Similarly to the evaluation unit 12 illustrated in FIG. 1 and the evaluation unit 206 illustrated in FIG. 4, the evaluation unit 31 calculates an insight score for a combination of a plurality of grouped insight subjects. The evaluation unit 31 differs from the evaluation units 12 and 206 in that the evaluation unit 31 can evaluate three or more insight subjects together, in other words, the evaluation unit 31 can calculate one insight score that indicates the presence or absence of an insight in the three or more insight subjects.

Specifically, the evaluation unit 31 calculates an insight score for a combination of insight subjects on the basis of the degree of bias in contribution degree of principal components obtained by carrying out principal component analysis on the plurality of grouped insight subjects. The principal component analysis can be carried out on any number of insight subjects. Thus, the information processing apparatus 3 according to the present example embodiment produces, in addition to the effects brought about by the information processing apparatuses 1 and 2 according to the first and second example embodiments, the effect of making it possible to evaluate three or more insight subjects together. Note that the details of the evaluation method and the reason why such evaluation is possible will be described later with reference to FIGS. 9 and 10.

The outlier detection unit 32, by representing data contained in the plurality of grouped insight subjects with use of the principal components which have been obtained by the principal component analysis by the evaluation unit 31, detects an outlier contained in the data. Thus, the information processing apparatus 3 according to the present example embodiment produces, in addition to the effects brought about by the information processing apparatuses 1 and 2 according to the first and second example embodiments, the effect of making it possible to efficiently detect an outlier with use of the results of the principal component analysis which has been carried out for evaluation. Note that the details of an outlier detection method and the reason why it is possible to detect the outlier in such a method will be described later with reference to FIGS. 9 and 10.

(Flow of Process Carried Out by Information Processing Apparatus 3)

A flow of a process carried out by the information processing apparatus 3 will be described with reference to FIG. 9. Note that it is assumed that a plurality of insight subjects have been grouped before the process in FIG. 9. That is, although not illustrated in FIG. 8, in the present example embodiment, it is assumed that the information processing apparatus 3 includes a configuration corresponding to the classification unit 11 (first example embodiment) or the classification unit 204 (second example embodiment). Note that the information processing apparatus 3 may include some or all of various configurations (of, for example, the data acquisition unit 201, the subject generation unit 202, and others) that the information processing apparatus 2 includes.

In S31, the evaluation unit 31 evaluates the group of insight subjects. More specifically, first, the evaluation unit 31 specifies data to be subjected to principal component analysis in each insight subject included in the group to be evaluated. For example, in a case where the insight subject is expressed in the form of I={subspace, breakdown, measure, aggregation}, the evaluation unit 31 need only use the data of the item “measure” in each insight subject as an object to be subjected to principal component analysis.

Next, the evaluation unit 31 carries out principal component analysis on the data specified as the object to be subjected to principal component analysis. For example, the evaluation unit 31 may generate a multi-dimensional correlation matrix from the data of the item “measure” in each insight subject and carry out principal component analysis using the correlation matrix. Through the principal component analysis, an eigenvalue and an eigenvector are calculated.

Subsequently, the evaluation unit 31 calculates the contribution ratio of each principal component with use of the calculated eigenvalue. Since the contribution ratio of each principal component can be regarded as the amount of information in its axial direction (eigenvector), the strength of the correlation between insight subjects can be quantitatively evaluated by examining the degree of bias in the contribution ratio of each principal component.

For example, FIG. 10 illustrates a bar graph 1001 showing the contribution ratios of principal components calculated by carrying out principal component analysis on insight subjects that are not correlated, and a bar graph 1002 showing the contribution ratios of principal components calculated by carrying out principal component analysis on insight subjects that are correlated. Note that, in FIG. 10, PC1 is a first principal component, PC2 is a second principal component, and PC3 is a third principal component.

In the bar graph 1001, the contribution ratios of PC1 to PC3 are approximately the same, and the degree of bias among the principal components is low. On the other hand, in the bar graph 1002, the contribution ratio of PC1 is the highest, and the contribution ratio of PC2 is about half of the contribution ratio of PC1, and the contribution ratio of PC3 is considerably low. The degree of bias is high as a whole. Thus, the presence or absence of correlation between insight subjects is clearly reflected in the degree of bias in the contribution ratio of each principal component.

Thus, if the degree of bias in the contribution ratio of each principal component is quantitatively evaluated, the result of the evaluation can be used as an insight score. For example, the contribution ratio of the first principal component may be used as the insight score. This is because, as illustrated in FIG. 10, when the degree of bias in the contribution ratio of each principal component is high (bar graph 1002), the contribution ratio of the first principal component PC1 is high compared to when the degree of bias in the contribution ratio of each principal component is low (bar graph 1001).

Further, as illustrated in FIG. 10, when the degree of bias in the contribution ratio of each principal component is high (bar graph 1002), there is one principal component (specifically PC1) having a prominently high contribution ratio among PC1 to PC3. On the other hand, when the degree of bias in the contribution ratio of each principal component is low (bar graph 1001), there is no principal component having a prominently high contribution ratio. Therefore, it is also possible to calculate the insight score by using, for example, a score function that receives the contribution ratios of the principal components as inputs and outputs a larger value as the contribution ratios received as the inputs contain a prominently high contribution ratio.

In a case where an attempt is made to detect a nonlinear correlation between the insight subjects, the evaluation unit 31 may carry out kernel principal component analysis with use of any kernel, instead of ordinary principal component analysis. In addition, in a case where the correlation matrix cannot be calculated due to, for example, difference in sampling granularity between records, the evaluation unit 31 may carry out the functional principal component analysis with use of the function data analysis.

In S32, the outlier detection unit 32 detects an outlier included in the grouped insight subjects. For example, in a case where the evaluation with use of the data of the item “measure” in each insight subject has been carried out in S31, the outlier detection unit 32 also detects an outlier in the data of the item “measure” in each insight subject.

The outlier detection is carried out by representing data contained in the plurality of grouped insight subjects with use of the principal components obtained by the principal component analysis carried out for the evaluation in S31.

1003 in FIG. 10 is a graph obtained by plotting points representing the sample data by the first principal component PC1 and the second principal component PC2 which have been obtained by principal component analysis on the sample data, on a coordinate plane that has a vertical axis representing the second principal component PC2 and a horizontal axis representing the first principal component PC1. In the plot after the principal component analysis, data at a distance from other data is also at a distance from other data in the original sample data. Thus, data at a distance from other data need only be detected as the outlier, like the plot indicated by “OUTLIER” in 1003.

For example, the outlier detection unit 32 may calculate the Hotelling T² statistic of the data represented by the principal components, and detect, as the outlier, the data in which the calculated T² statistic is remarkable. 1004 in FIG. 10 is a graph obtained by plotting the T² statistic calculated from the sample data shown in 1003 in FIG. 10, on a coordinate plane that has a horizontal axis representing the sample number and a vertical axis representing the T² statistic. The plot indicated by “OUTLIER” in 1003 in FIG. 10 has a larger T² statistic value than the other plots. Thus, the outlier detection unit 32 can detect the outlier with use of the T² statistic.

It is also known that the T² statistic follows the F-distribution or x²-distribution. Thus, the outlier detection unit 32 may calculate a score with use of a p-value obtained on the basis of a statistical test. In this case, the outlier detection unit 32 need only detect an outlier with use of the calculated score.

This is the end of the process in FIG. 9. Note that the evaluation result in S31 and the outlier detected in S32 are stored as the evaluation result data. The evaluation result data may be outputted as it is. Alternatively, as in the second example embodiment, output data may be generated from the evaluation result data so that the generated output data is outputted.

### Reference Example

The above-described evaluation method carried out by the evaluation unit 31 is suitable for detection of a cross-sectional composite insight and is also suitable for detection of an insight which is not cross-sectional, that is, an insight in one data set. Thus, the information processing apparatus 3 described above does not necessarily need to include a configuration corresponding to the classification unit 204 (second example embodiment) or the classification unit 11 (first example embodiment).

The information processing apparatus 3 according to the present reference example includes an acquisition unit that acquires a plurality of insight subjects to be evaluated and the above-described evaluation unit 31. The plurality of insight subjects acquired by the acquiring unit need only be insight subjects generated from at least one data set. That is, the present reference example differs from the example embodiments described above in that, in the present reference example, it is not essential to use a plurality of insight subjects generated from a plurality of data sets.

According to the information processing apparatus in the present reference example, the evaluation unit 31 calculates, on the basis of the degree of bias in contribution degree of principal components obtained by carrying out principal component analysis on the plurality of insight subjects acquired by the acquisition unit, an insight score for the combination of insight subjects. Thus, it is possible to solve the conventional problem that it was not possible to evaluate three or more insight subjects together.

Further, an analysis method according to the present reference example further includes: at least one processor acquiring a plurality of insight subjects to be evaluated; and the at least one processor calculating an insight score for a combination of the insight subjects on the basis of the degree of bias in contribution degree of principal components obtained by carrying out principal component analysis on the plurality of acquired insight subjects. Further, an analysis program according to the present reference example causes a computer to carry out: a process of acquiring a plurality of insight subjects to be evaluated; and a process of calculating an insight score for a combination of the insight subjects on the basis of the degree of bias in contribution degree of principal components obtained by carrying out principal component analysis on the plurality of acquired insight subjects. These analysis methods and analysis programs also solve the conventional problem that it was not possible to evaluate three or more insight subjects together.

### VARIATIONS

In the above-described first example embodiment, the processes carried out by one information processing apparatus 1 may be shared by a plurality of information processing apparatuses. In other words, some of the processes carried out by the information processing apparatus 1 may be carried out by at least one other information processing apparatus. In other words, in a case where each of the above-described processes is carried out by at least one processor, the at least one processor may be a processor which is provided in one information processing apparatus 1 is provided, or may be a processor(s) which is/are provided in each of separate information processing apparatuses. The same applies to the information processing apparatus 2 in the above-described second example embodiment and the information processing apparatus 3 in the third example embodiment.

Software Implementation Example

The functions of part of or all of the information processing apparatuses 1 to 3 can be realized by hardware such as an integrated circuit (IC chip) or can be alternatively realized by software.

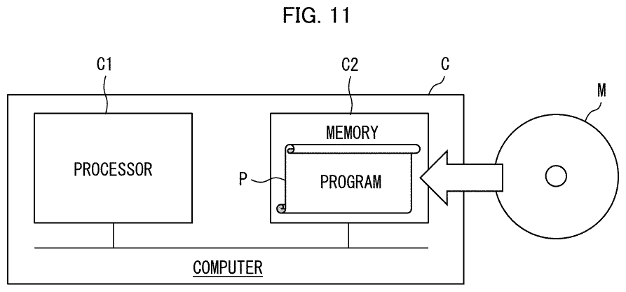

In the latter case, each of the information processing apparatuses 1 to 3 is realized by, for example, a computer that executes instructions of a program which is software realizing the foregoing functions. FIG. 11 illustrates an example of such a computer (hereinafter, referred to as “computer C”). The computer C includes at least one processor C1 and at least one memory C2. The memory C2 stores a program P for causing the computer C to function as the information processing apparatuses 1 to 3. In the computer C, the processor C1 reads the program P from the memory C2 and executes the program P, so that the functions of the information processing apparatuses 1 to 3 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

Additional Remark 2

Some of or all of the foregoing example embodiments can also be described as below. Note, however, that the present invention is not limited to the following example aspects.

(Supplementary Note 1)

An information processing apparatus including: a classification means that groups, by insight to be detected, a plurality of insight subjects each being data generated from each of a plurality of data sets by associating a plurality of data items contained in each of the plurality of data sets with each other; and an evaluation means that calculates, for a combination of the plurality of insight subjects which have been grouped, an evaluation value for determining the presence or absence of an insight. This configuration makes it possible to detect an insight between a plurality of data sets.

(Supplementary Note 2)

The information processing apparatus described in supplementary note 1, further including: a description unification means that unifies descriptions in the plurality of insight subjects, wherein the classification means groups the insight subjects in which the descriptions have been unified. This configuration makes it possible to detect a cross-sectional composite insight even for data sets with nonuniform descriptions.

(Supplementary Note 3)

The information processing apparatus described in supplementary note 1 or 2, further including: a granularity unification means that unifies granularities of data in the plurality of insight subjects, wherein the evaluation means calculates the evaluation value for the plurality of insight subjects in which the granularities have been unified. This configuration makes it possible to detect a cross-sectional composite insight even for data sets that include nonuniform granularities.

(Supplementary Note 4)

The information processing apparatus described in supplementary note 1 or 2, wherein the evaluation means calculates the evaluation value by dynamic time warping or by functional data analysis. This configuration makes it possible to detect a cross-sectional composite insight even for data sets that include nonuniform granularities.

(Supplementary Note 5)

The information processing apparatus described in any one of supplementary notes 1 to 4, wherein the evaluation means calculates the evaluation value on a basis of a degree of bias in contribution degree of principal components obtained by subjecting the plurality of insight subjects which have been grouped to principal component analysis. This configuration makes it possible to evaluate three or more insight subjects together.

(Supplementary Note 6)

The information processing apparatus described in supplementary note 5, further including: an outlier detection means that, by representing data contained in the plurality of insight subjects which have been grouped with use of the principal components obtained by the principal component analysis, detects an outlier contained in the data. This configuration makes it possible to efficiently detect an outlier with use of the results of principal component analysis which has been carried out for evaluation.

(Supplementary Note 7)

An analysis method including: at least one processor grouping, by insight to be detected, a plurality of insight subjects each being data generated from each of a plurality of data sets by associating a plurality of data items contained in each of the plurality of data sets with each other; and the at least one processor calculating, for a combination of the plurality of insight subjects which have been grouped, an evaluation value for determining the presence or absence of an insight. This configuration makes it possible to detect an insight between a plurality of data sets.

(Supplementary Note 8)

An analysis program for causing a computer to carry out: a process of grouping, by insight to be detected, a plurality of insight subjects each being data generated from each of a plurality of data sets by associating a plurality of data items contained in each of the plurality of data sets with each other; and a process of calculating, for a combination of the plurality of insight subjects which have been grouped, an evaluation value for determining the presence or absence of an insight. This configuration makes it possible to detect an insight between a plurality of data sets.

(Supplementary Note 9)

An information processing apparatus including at least one processor, the at least one processor carrying out: a process of grouping, by insight to be detected, a plurality of insight subjects each being data generated from each of a plurality of data sets by associating a plurality of data items contained in each of the plurality of data sets with each other; and a process of calculating, for a combination of the plurality of insight subjects which have been grouped, an evaluation value for determining the presence or absence of an insight.

Note that this information processing apparatus may further include a memory. In this memory, a program for causing the processor to carry out the grouping process and the evaluation process may be stored. Alternatively, the program may be stored in a non-transitory, tangible computer-readable storage medium.

### REFERENCE SIGNS LIST

1: information processing apparatus
11: classification unit (classification means)
12: evaluation unit (evaluation means)
2: information processing apparatus
203: description unification unit (description unification means)
204: classification unit (classification means)
205: granularity unification unit (granularity unification means)
206: classification unit (classification means)
3: information processing apparatus
31: classification unit (classification means)
32: outlier detection unit (outlier detection means)

What is claimed is:

1. An information processing apparatus comprising:
at least one processor, the at least one processor carrying out:
a classification process of grouping, by insight to be detected, a plurality of insight subjects each being data generated from each of a plurality of data sets by associating a plurality of data items contained in each of the plurality of data sets with each other; and
an evaluation process of calculating, for a combination of the plurality of insight subjects which have been grouped, an evaluation value for determining the presence or absence of an insight.

2. The information processing apparatus according to claim 1, wherein:
the at least one processor further carries out a description unification process of unifying descriptions in the plurality of insight subjects; and
in the classification process, the at least one processor groups the insight subjects in which the descriptions have been unified.

3. The information processing apparatus according to claim 1, wherein:
the at least one processor further carries out a granularity unification process of unifying granularities of data in the plurality of insight subjects; and
in the evaluation process, the at least one processor calculates the evaluation value for the plurality of insight subjects in which the granularities have been unified.

4. The information processing apparatus according to claim 1, wherein, in the evaluation process, the at least one processor calculates the evaluation value by dynamic time warping or by functional data analysis.

5. The information processing apparatus according to claim 1, wherein, in the evaluation process, the at least one processor calculates the evaluation value on a basis of a degree of bias in contribution degree of principal components obtained by subjecting the plurality of insight subjects which have been grouped to principal component analysis.

6. The information processing apparatus according to claim 5, wherein:
the at least one processor further carries out an outlier detection process of, by representing data contained in the plurality of insight subjects which have been grouped with use of the principal components obtained by the principal component analysis, detecting an outlier contained in the data.

7. An analysis method comprising:
at least one processor grouping, by insight to be detected, a plurality of insight subjects each being data generated from each of a plurality of data sets by associating a plurality of data items contained in each of the plurality of data sets with each other; and
the at least one processor calculating, for a combination of the plurality of insight subjects which have been grouped, an evaluation value for determining the presence or absence of an insight.

8. A computer-readable non-transitory storage medium storing an analysis program for causing a computer to carry out:
a process of grouping, by insight to be detected, a plurality of insight subjects each being data generated from each of a plurality of data sets by associating a plurality of data items contained in each of the plurality of data sets with each other; and
a process of calculating, for a combination of the plurality of insight subjects which have been grouped, an evaluation value for determining the presence or absence of an insight.
